(19) United States
(12) Patent Application Publication
(10) Pub. No.: US 2022/0154806 A1
(43) Pub. Date: May 19, 2022

(54) CHAIN TENSIONING OF A HYBRID DRIVE MODULE

(71) Applicant: BorgWarner Sweden AB, Landskrona (SE)

(72) Inventor: MARTIN GERLACH, Neulussmeim (DE)

(21) Appl. No.: 17/433,540

(22) PCT Filed: Feb. 25, 2020
(86) PCT No.: PCT/EP2020/054943

§ 371 Date: Aug. 24, 2021

(30) Foreign Application Priority Data
Feb. 25, 2019 (SE) 1950240-0

(51) Int. Cl. F16H 7/14

(52) U.S. Cl. CPC F16H 7/14; F16H 2007/088

(57) ABSTRACT

A chain tensioning device (400), comprising a base member (410) being provided with a centering member (440) being configured to be received by a cassette (200), said cassette (200) supporting a first sprocket (122) of a chain drive (120), the second sprocket (124) being moveable at least in a radial direction in relation to the cassette (200), and a tensioning pin (450) being configured to be received in a recess (512) concentric with a second sprocket (124) of the chain drive (120) in the cassette (200).

### TECHNICAL FIELD

The present invention relates to a hybrid drive module, and in particular to a chain tensioning device for a cassette of such a hybrid drive module as well as to a method for tensioning a chain.

### BACKGROUND

Hybrid powertrains for passenger cars are gaining interest and various solutions for such applications have been proposed during the recent years. Especially it has been suggested to provide the hybrid functionality as a separate module which is added to the existing powertrain. One example of an existing hybrid drive module includes a first sprocket which is intended to be connected to the crank shaft of the internal combustion engine indirectly via a disconnect clutch arranged in series with a dual mass flywheel, and an electrical motor, preferably a 48V electrical motor, being drivingly connected to a second sprocket. The sprockets are connected by means of a belt, thus forming a belt drive, in order to allow for various driving modes such as pure electrical driving, recuperation, traction mode, and boost. In this prior art system the electrical motor, the flywheel, the clutch, and the belt drive are formed as a standalone module which can be added to an existing powertrain.

Other prior art modules are implemented using a chain drive instead of a belt drive.

During assembly of such standalone module to the powertrain, the chain must be set at a defined pre-load, which is a time consuming process. Therefore it would be desirable to provide an improved chain tensioning device and method for tensioning the chain which reduces the work required when mounting the hybrid drive module to the powertrain.

### SUMMARY

It is thus an object of the teachings herein to provide an improved assembly method, as well as an improved chain tensioning apparatus, overcoming the disadvantages of prior art solutions.

An idea of the present invention is therefore to provide a chain tensioning device which can be secured to a cassette of the hybrid drive module during manufacturing, and which is removed only after mounting to the existing powertrain.

According to a first aspect, a chain tensioning device is provided. The chain tensioning device is configured to be used with a cassette supporting a first sprocket of a chain drive, and also housing a second sprocket of the chain drive. The chain tensioning device comprises a base member being provided with a centering member, which is configured to be received by the associated cassette. The device further comprises a tensioning pin being configured to be received in a recess concentric with the second sprocket of the chain drive in the cassette, the second sprocket being moveable at least in a radial direction in relation to the cassette. The chain tensioning device further comprises a displacement mechanism being configured to move, such as selectively manipulate, the position of the tensioning pin in relation to the centering member between an idle state and a pre-loading state of a chain of the chain drive. The chain drive of the cassette, preferably of a hybrid drive module, can thus be tensioned without having to be mounted to an engine. The chain tensioning device also facilitates keeping the desired tension on the chain during transportation, i.e. as a transport securing device. This is beneficial as manufacture of the cassette/hybrid drive module and assembly of the cassette with an engine may take place at sites being geographically separated, which requires the cassette and/or the engine to be transported. The chain tensioning device will in such situations, regardless of the distance that it is necessary to transport the cassette, facilitate that the cassette can securely be handled/transported, reducing the risk of that the tension level of the chain changes unintentionally.

The centering member may further comprise a plurality of centering pins, distributing and sharing the loads from the tensioning of the chain into the cassette.

In one embodiment, the chain tensioning device comprises four centering pins that are distributed in a cross-shape.

Furthermore, the displacement mechanism may comprises a screw acting on the tensioning pin. The screw is preferably self-locking, and facilitates adjustment of the chain tension to a desired level. Being self-locking, the tensioning device will maintain the desired tension, for instance during transportation of the cassette.

In one embodiment, the chain tensioning device further comprises at least one locking pin receivable in a hole in the cassette, the locking pin upon manipulation is configured to lock the chain tensioning device in place against the cassette to facilitate tensioning of the chain.

Further still, the tensioning pin may be slidably supported by the base member such that the tensioning pin may only move relative the base member in a direction towards or away from the first sprocket.

In a second aspect is a hybrid drive module provided, comprising a cassette supporting a first sprocket of a chain drive, and a second sprocket of said chain drive. The hybrid drive module further comprising a chain tensioning device according to the first aspect attached to said second sprocket by inserting the tensioning pin into a recess concentric with said second sprocket and to the cassette by inserting the centering member into at least one hole in the cassette. The hybrid drive module can thus be transported with the chain tensioned to a desired level, facilitating the assembly of the hybrid drive module and an engine.

In one embodiment, the holes into which the centering member of the chain tensioning device is insertable are crankshaft access holes.

In another embodiment, the holes into which the centering member of the chain tensioning device is insertable are separate from crankshaft access holes.

In a third aspect is an engine assembly provided, comprising an internal combustion engine a thereto mounted hybrid drive module according to second aspect.

In a fourth aspect is a method for tensioning a chain of a chain drive provided, using the chain tensioning device of the first aspect. The chain connects a first sprocket supported by a cassette and a second sprocket in the cassette, the method comprising arranging the centering member of the chain tensioning device in at least one hole of the cassette, arranging a displaceable tensioning pin of the chain tensioning device in a recess concentric with the second sprocket, and manipulating a distance between the centering pins and the tensioning pin such that the chain is pre-loaded to a predetermined level. The chain tensioning device is thus held in place by its interaction with the cassette and the second sprocket respectively, allowing the chain to be tensioned and kept in correct tension for instance during transportation of the cassette. The cassette is, as mentioned, preferably a cassette of a hybrid drive module.

The method may further comprise mounting the cassette with the chain tensioning device to an engine, removing the chain tensioning device after at least one screw attaching the cassette to the engine is tightened, and tightening the screws which previously were non-accessible because of the presence of the chain tensioning device. The cassette, preferably of a hybrid drive module, can thus be mounted to the engine with the chain tensioning device still attached. By attaching at least one screw, preferably at least one to the cassette and at least one to the second sprocket, the cassette will be secured with the correct chain tension to the engine.

### BRIEF DESCRIPTION OF THE DRAWINGS

Embodiments of the teachings herein will be described in further detail in the following with reference to the accompanying drawings which illustrate non-limiting examples on how the embodiments can be reduced into practice and in which:

FIG. 1 shows a schematic outline of a hybrid drive module according to an embodiment,

FIG. 2 is an isometric view of an embodiment of a hybrid drive module mounted to an internal combustion engine,

FIG. 3 is a an front view of parts of a hybrid drive module according to an embodiment,

FIG. 4 is a front view of a hybrid drive module according to embodiments without tension applied to the chain,

FIG. 5a is a cross-sectional view of a chain tensioning device according to an embodiment, when arranged in an idle state,

FIG. 5b is a planar isometric view of the chain tensioning device of FIG. 5a,

FIG. 5c is a cross-sectional view of the chain tensioning device of FIG. 5a, now arranged in a pre-loading state,

FIG. 5d is a planar isometric view of the chain tensioning device of FIG. 6c,

FIG. 6 is a cross-sectional view of the chain tensioning device of FIGS. 6a-d prior to being mounted to a hybrid drive module,

FIG. 7 is a cross-sectional view of the chain tensioning device of FIGS. 6a-d when mounted to a hybrid drive module,

FIG. 8 is a front view of a hybrid drive module when a chain tensioning device, arranged in an idle state, is mounted thereto,

FIG. 9 is a cross-sectional view of the chain tensioning device of FIGS. 6a-d when mounted to a hybrid drive module and arranged in a pre-loading state,

FIG. 10 is a front view of the hybrid drive module, having the chain tensioning device arranged thereto in a pre-loading state,

FIG. 11 is a flowchart of a method for tensioning a chain of a hybrid drive module, and

FIGS. 12a-12b are cross-sectional views of the chain tensioning device according to an embodiment.

### DETAILED DESCRIPTION

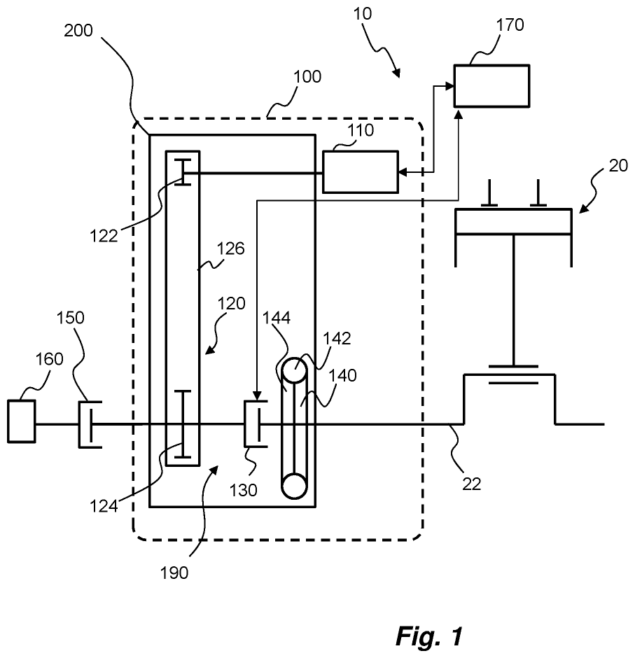

Starting in FIG. 1, a schematic layout of an engine assembly 10 of a vehicle is shown. The vehicle is typically a passenger car, and the engine assembly 10 comprises an internal combustion engine 20 and a hybrid drive module 100. The hybrid drive module 100 is mechanically connected to a crankshaft 22 of the internal combustion engine 20 in order to provide additional drive torque to a transmission 160 arranged in series with the hybrid drive module 100. Hence, the transmission is also connected to the crank shaft 22 as is evident from FIG. 1.

The hybrid drive module 100 comprises an electrical motor 110 and a continuous member drive 120, here in the form of a chain drive 120, connecting the electrical motor 110 with the crank shaft 22. The electrical motor 110 is for this purpose driving a first sprocket 122 of the chain drive 120, whereby upon activation of the electrical motor 110 rotational movement of the first sprocket 122 is transmitted to a second sprocket 124 of the chain drive 120 via a chain 126.

The second sprocket 124 is drivingly connected to the crank shaft 22 via one or more couplings. In the embodiment shown in FIG. 1, the second sprocket 124 is connected to the output of a disconnect clutch 130 receiving driving torque from a dual mass flywheel 140. For parallel two-clutch systems, commonly denoted hybrid P2 systems, the disconnect clutch 130 is often referred to as the C0 clutch. The dual mass flywheel 140, which could be replaced by another torsional damping/absorption device, receives input torque directly from the crank shaft 22. However, for the purpose of the present embodiments either the disconnect clutch 130 and/or the dual mass flywheel 140 (or its substitute) could be omitted or replaced by another suitable coupling.

Also illustrated in FIG. 1 is a further optional clutch 150, here representing a launch clutch. Again referring to P2 systems, the launch clutch 150 is often referred to as the C1 clutch. The launch clutch 150 is arranged downstream, i.e. on the output side of the hybrid drive module 100 upstream the transmission 160. It should be realized that the launch clutch 150 could be replaced by a torque converter or similar.

The electrical motor 110 is preferably a 48V motor/alternator which thus can be used to provide hybrid functionality to the existing powertrain of the vehicle. For other embodiments, also possible within the scope of this application, high voltage hybrid electrical motors may be utilized. More specifically, the provision of the chain drive 120 allows for modularity with high voltage hybrid electrical motors in comparison to if a belt drive would be used. A belt drive could never accommodate the much higher loads provided by a more powerful high voltage hybrid electrical motor.

The crank shaft 22 provides input torque to a primary inertial mass 142 of the dual mass flywheel 140. A secondary inertial mass 144 of the dual mass flywheel 140 is in turn connected to an input shaft of the disconnect clutch 130, here in the form of a limited slip coupling. The output shaft of the disconnect clutch 130 is connected to the second sprocket 124 carrying the chain 126. Preferably, one or more springs may be provided connecting the internal masses 142, 144 to each other such that the secondary inertial mass 144 may rotate relative the primary inertial mass 142 whereby the springs may deform causing a reduction of torsional vibrations being transmitted from the internal combustion engine 20.

The dual mass flywheel 140 and the disconnect clutch 130 are preferably arranged concentrically around the crank shaft 22, thereby reducing the axial length of the hybrid drive module 100.

As is further shown in FIG. 1 the electrical motor 110 as well as the clutch 130 are controlled by a control unit 170. Activation of the electrical motor 110 as well as activation and control of the clutch 130 is thereby achieved by means of the control unit 170 transmitting one or more control signals. The outline of a cassette 200 is also shown, which encloses parts of the hybrid drive module 100. As can be seen, the electric motor 110 may be connected to the cassette 200.

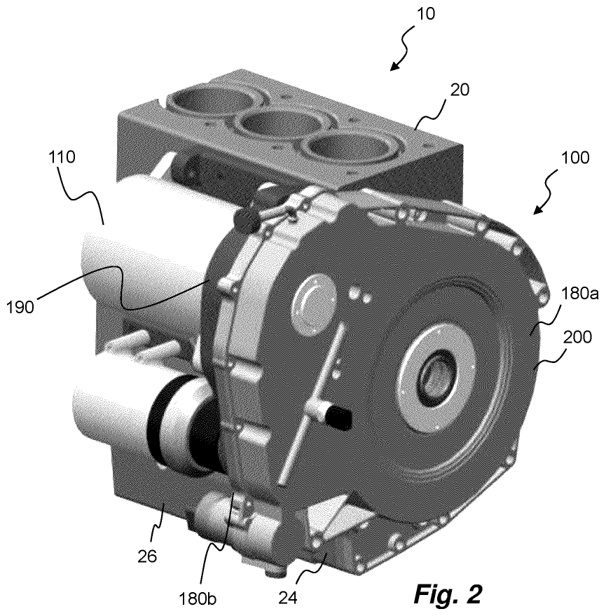

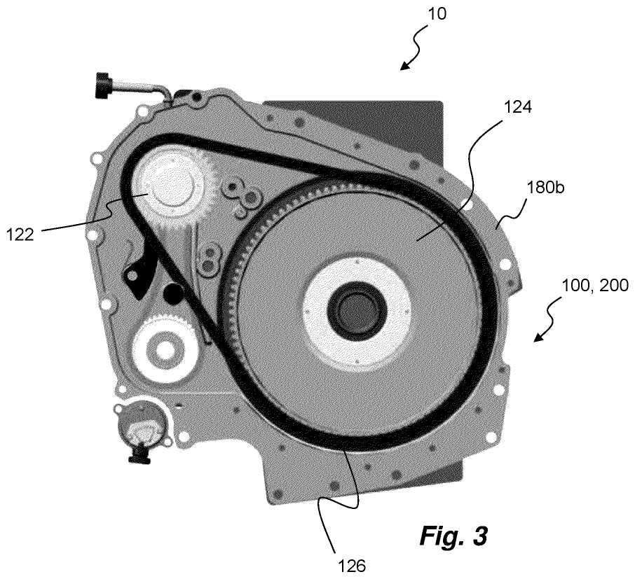

In FIGS. 2 and 3, an engine assembly 10 is shown comprising an engine 20 and a thereto mounted hybrid drive module 100. As can be seen, the hybrid drive module 100 which comprises the cassette 200 may have an outer cover 180a and a rear cover 180b. The cassette 200 forms the cover or housing in which i.a. the chain drive 120 of the hybrid drive module 100 is arranged. The cassette 200 is attachable to an end section 24 of an engine block 26 of the internal combustion engine 20, and to an ear structure 190 attached to the end section 24 and extending outwards from the engine block 26. The ear structure 190 is provided for attachment of the electrical motor 110.

With reference to FIG. 3, the engine assembly is shown with the outer cover 180 removed.

The cassette 200 supports the first sprocket 122 of the chain drive 120, the first sprocket 122 being rotationally secured to the inside of the cassette 200.

The outer cover 180 forms a closure for the cassette 200, and is preferably removable after that the cassette 200 is mounted to the engine 20. The purpose of the cassette 200 is consequently, as mentioned, to provide a sealed closure for the hybrid drive module 100, and to allow mounting of the components associated with the cassette 200 as a unit to the engine 20.

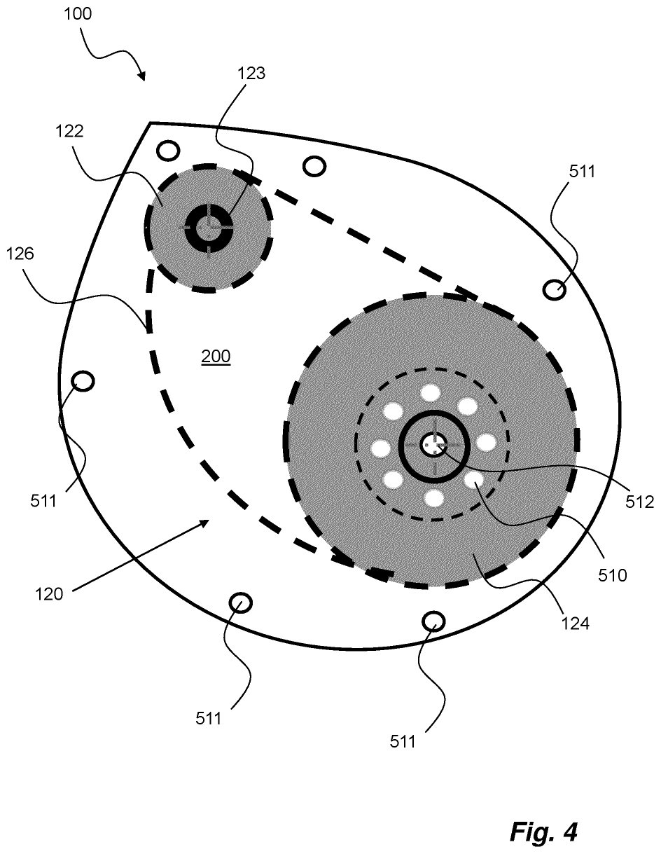

Now referring to FIG. 4, the principal arrangement of the chain drive 120 within the cassette 200 is shown, here rendered transparent for purpose of illustration. The cassette 200 is preferably a part of a hybrid drive module 100, and the description herein will be focused on such a cassette 200. However, it is possible that the teachings herein could be used for chain drives in other applications as well.

The first sprocket 122 is rotatably supported by the cassette 200, optionally by means of a radial bearing 123 such that it may rotate but not translate in relation to the cassette 200. The chain 126 runs along the first sprocket 122, as well as around the second sprocket 124, for torque transfer from the electric motor 110 (driving the first sprocket 122) to the crank shaft of the internal combustion engine 22 (driving the second sprocket 124). As is evident, torque may also be transferred in the opposite direction. The second sprocket 124 is arranged within the cassette 200, and is configured to be connected to the crankshaft 22 of the engine 20 when the hybrid drive module 100 is connected thereto. The second sprocket 124 is however configured to be radially moveable in relation to the cassette 200 when the cassette 200 is not mounted to the engine 20, to allow tensioning of the chain 126.

Seen also in FIG. 4 are a plurality of holes 510 in the cassette 200 for crankshaft bolt access, bolt holes 511 for variable position mounting of the cassette 200 to the end section 24 of the engine block 26 and a center recess 512 concentric with the second sprocket 124. As is clear from FIG. 4, the chain 126 is not subjected to a pre-load or tensioning. As mentioned previously it would be desirable to assemble the cassette 200 of the hybrid drive module 100 with a pre-loaded chain 126 as this would facilitate savings in time and cumbersome work when the hybrid drive module 100 is mounted to the engine block 22.

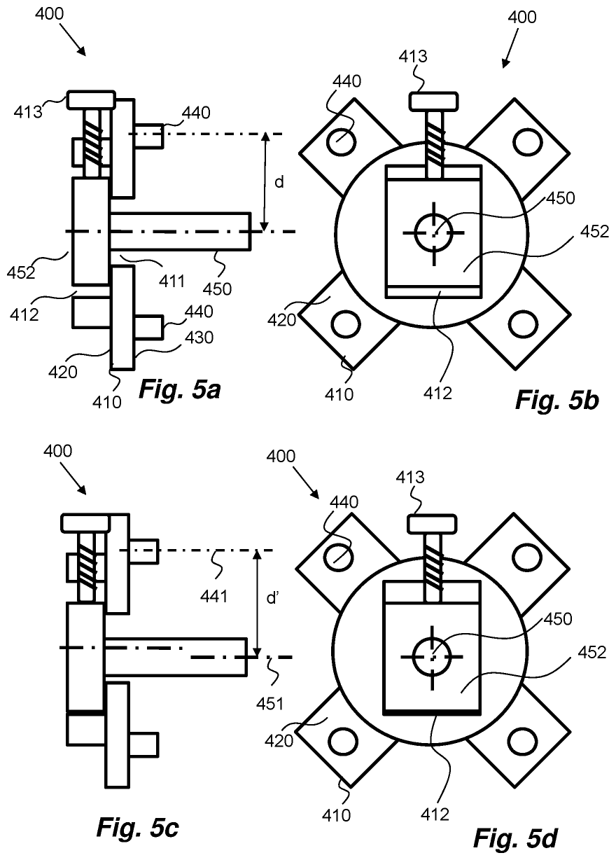

Now referring to FIGS. 5a-d, an embodiment of a chain tensioning device 400 will be described.

The chain tensioning device 400 comprises a base member 410, and a centering member 440, preferably in the shape of a number of centering pins 440 extending from a distal face 430 of the base member 410 and in a direction inwards, i.e. towards the hybrid drive module 100 during use. The chain tensioning device 410 preferably comprises more than two centering pins 440, even more preferably four centering pins 440 arranged at a distance from each other. As is clear from FIG. 5b, the centering pins 440 may be arranged in cross-like configuration.

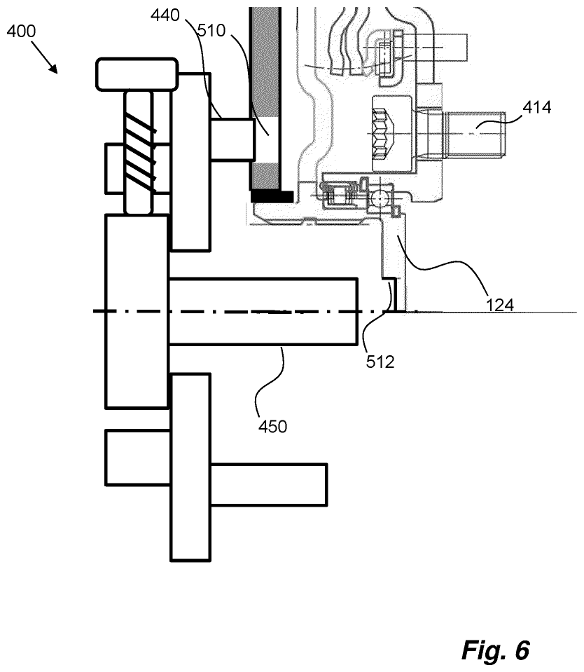

The chain tensioning device 400 further comprises a tensioning pin 450 which is configured to extend through the base member 410 at a recess 411 thereof, and to be received by the center recess 512 of the cassette 200 of the hybrid drive module 100. Further to this, the chain tensioning device 400 comprises a displacement mechanism 413, such as a force exerting screwing member, capable of displacing the tensioning pin 450 in relation to the base member 410 such as to manipulate the position of tensioning pin 450 within the recess 411. As is shown e.g. in FIG. 6, the center recess 512 is preferably formed in the second sprocket 124.

In the embodiment of FIGS. 5a-5d, the tensioner pin 450 has a rectangular head portion 452 arranged to be slidably received in a slot 412 of the base member 420. Consequently, the movement of the tensioner pin 450 is restricted to a direction being aligned with the desired tensioning direction of the chain 126. The slot 412 should preferably be arranged such that when the device 400 is attached to a hybrid drive module 100, or to the cassette 200 thereof, the slot 412 will only allow movement of the pin 450 towards or away from the first sprocket 122.

In further embodiments, alternatives to the centering member 440 (or the centering pins 440) may be a circular track (not shown) or the like which may be received in a corresponding slot in the cassette 200 to facilitate centering of the chain tensioning device 400 relative the cassette 200 and the center recess 512.

In FIG. 5b an exemplary shape of the base member 410 is shown. The base member 410 may have any suitable shape, however an advantageous shape may comprise a cross-shape with a circular center since the surface area is rendered small, thereby occupying a smaller surface of the cassette and thus allowing access e.g. to holes 510 in the cassette 200 for crankshaft bolts access.

The chain tensioning device 400 is in FIGS. 5c-d shown in a pre-loading state 480. It can be readily deducted from the drawings that the position of the tensioning pin 450 has been manipulated by means of the tensioning member 413 and thus, the distance d between the center axis 451 of the tensioning pin 450 and the center axis 441 of the centering pin 440 has changed. In the illustrated example, the manipulation of the position of the tensioner pin 450 has caused an increase in the distance d′ from the center axis 451 of the centering pin 450 to a respective center axis 441 of one or more centering pins 440 arranged around said centering pin 450, thus allowing for tensioning of the chain 126.

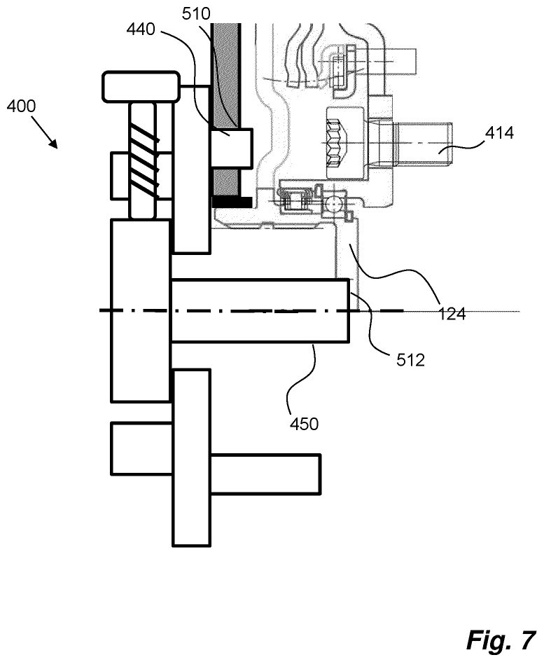

Now referring to FIG. 6, tensioning of the chain 126 will be further described. The tensioning may include configuring the chain tensioning device 400 in an idle state and aligning the one or more centering pins 440 of the pre-loading device 400 with one or more of the corresponding holes 510 in the cassette 200. The tensioning may also comprise aligning the tensioning pin 450 with the center recess 512. The arrangement resulting from aligning the centering pins 440 and the tensioning pin 450 to be received in the cassette 200, and the center recess 512 respectively, is shown in FIG. 7 where the tensioning device 400 is arranged against the cassette 200 in the idle state, i.e. without tensioning the chain 126.

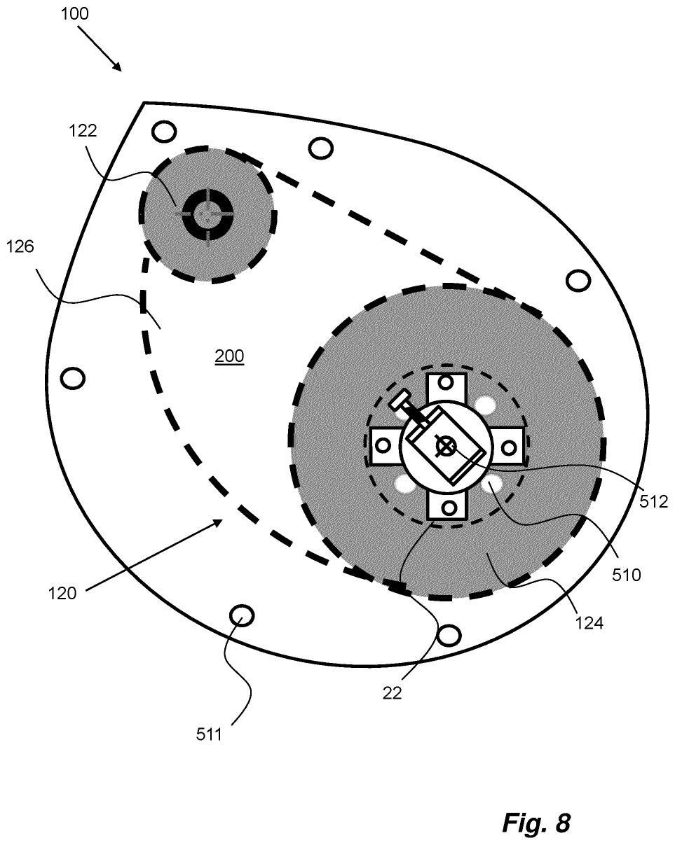

In FIG. 8, the chain tensioning device 400 has been mounted to the hybrid drive module 100, specifically to the cassette 200 and the second sprocket 124 thereof, prior to mounting the hybrid drive module 100 to the engine 20.

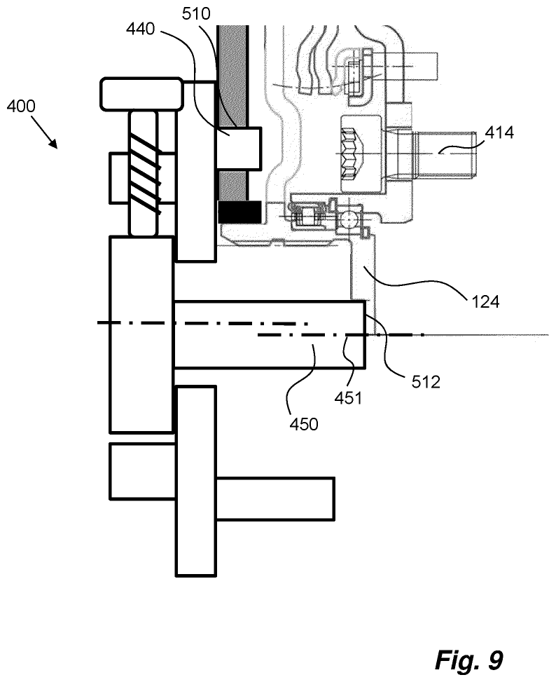

At this stage, tensioning of the chain 126 is possible. With reference to FIG. 9, tensioning of the chain 126 is accomplished by accessing the displacement mechanism 413. The displacement mechanism 413 may for example comprise a screwing member 413, which upon rotation will be displaced and thus causing the head portion 452 of the tensioner pin 450 to slide in the slot 412 and the consequently manipulating the position of the tensioning pin 450 in relation to the base member 410. FIG. 9 thus shows the chain tensioning device 400 in a pre-loading state, where the chain 126 is tensioned to a desired, predetermined level.

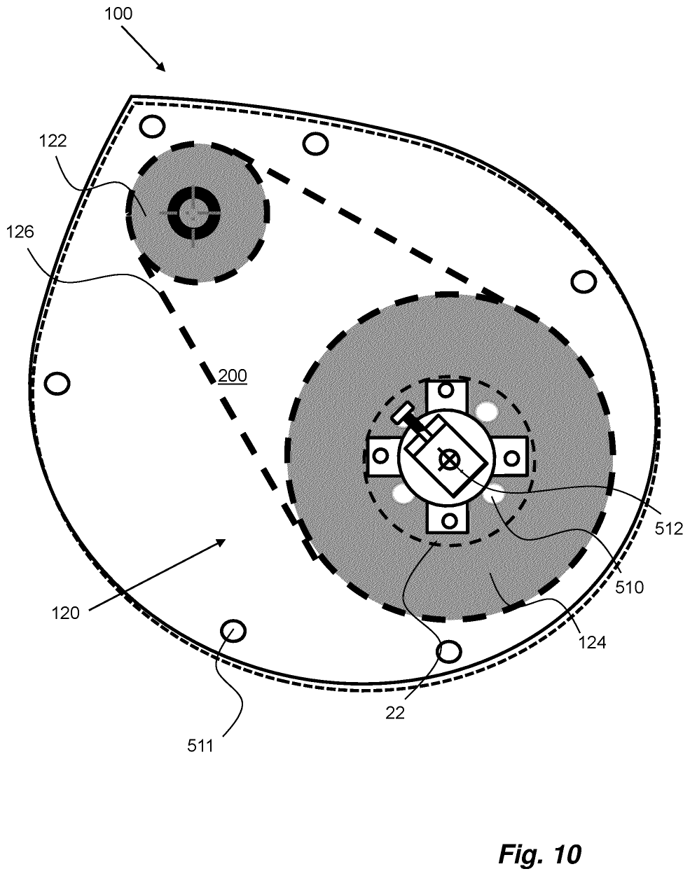

In FIG. 10 this is further shown, i.e. that the tensioning pin 450 has been moved relative the centering pins 440 such that the first sprocket 122 moves away from the second sprocket 124, by the movement of the second sprocket 124 in relation to the cassette 200.

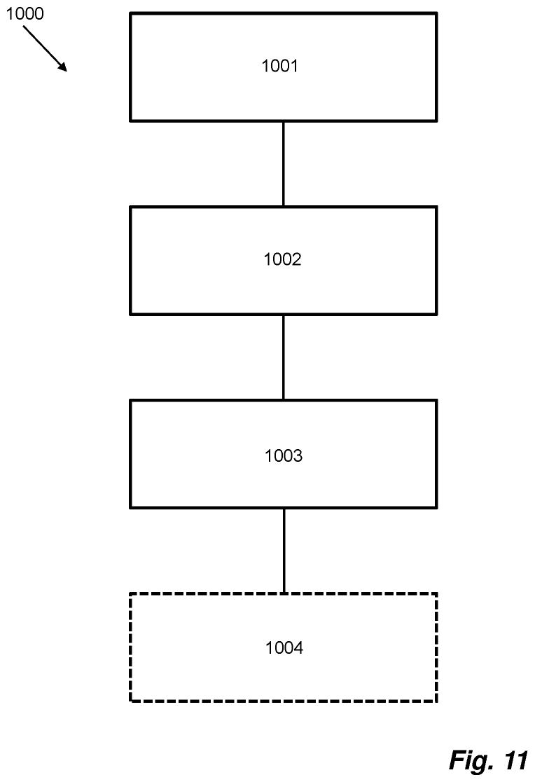

FIG. 11 shows a schematic flowchart of the method 1000 for tensioning a chain in a cassette 200 of a hybrid drive module 100. The method 1000 comprises arranging of the centering member 440, i.e. one or more of the centering pins 440 of the chain tensioning device 400, in a corresponding hole 510, 514 in the cassette 200 of the hybrid drive module 10. The displaceable tensioning pin 450 of the chain tensioning device 400 is arranged 1002 in the center recess 512. The recess 512 is concentric with the second sprocket 124. The chain tensioning device 400 is thereby ready for tensioning of the chain 126, whereby the distance between the centering pins 440 and the tensioning pin 450 is manipulated 1003 such that the chain 126 is pre-loaded to a predetermined level. The distance is manipulated 1003, as is explained above, by using the displacement mechanism 413.

At this stage the chain has been pre-loaded, or tensioned, and the hybrid drive module 100 is thereby ready to be mounted 1004 to the engine block of the internal combustion engine 20. The chain drive 120 of the hybrid drive module 100 may thus be pre-loaded at a first geographic location being different from a second geographic location, where the hybrid drive module 100 attached to the engine block of the internal combustion engine 20.

Mounting 1004 of the hybrid drive module 100 preferably is performed by bolting the hybrid drive module 100 to the crankshaft 22 by means of pre-mounted screws 414 (see FIG. 6) accessible via the holes 510 of the cassette 200, and bolting the cassette 200 to the engine block via screws inserted into holes 511 (see FIG. 4). Thereafter may the chain tensioning device 400 be removed, and final mounting is accomplished by fastening the screws 414 which previously were non-accessible because of the presence of the chain tensioning device 400.

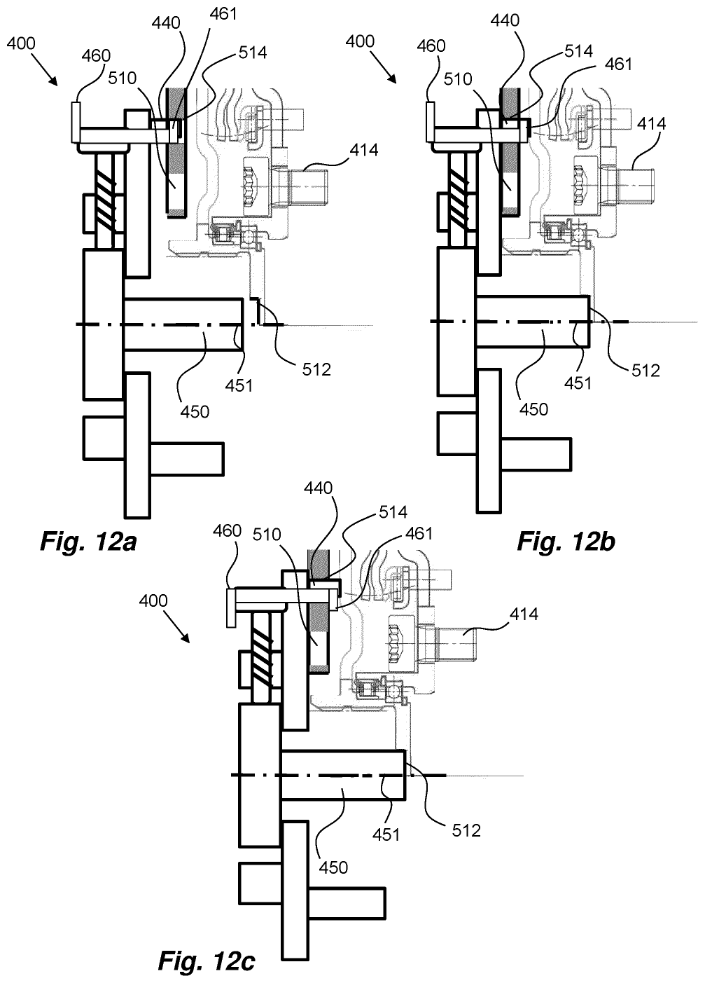

Turning now to FIGS. 12a to 12c, in which another embodiment of the chain tensioning device 400 is shown. Here, the device 400 is attachable to holes 514 in the cassette 200 by the centering member 440 in the shape of centering pins 440 in the manner which is explained in relation to the other embodiments herein. The holes 514 are however separate from the holes 510 that allow access to the crankshaft screws 414, preferably being both radially and angularly offset from the crankshaft access holes 510.

The device 400 can consequently be attached to the cassette 200 without obstructing access, or at least reducing said obstruction, to the crankshaft screws 414, further facilitating mounting of the hybrid drive module 100 to the engine 20. As is shown, the device 400 may further comprise at least one locking pin 460. The locking pin 460 serves to hold the device 400 securely in place during tensioning of the chain 126 and during transportation of the module 100 with the tensioning device 400 attached.

The device 400 is arranged on the cassette 200 into the position shown in FIG. 12b, where the locking pin 460 is arranged in the hole 514 in an unlocked state. The pin 460 is then maneuvered into the locked position, which is shown in FIG. 12c. In the locked position, a latch 461 of the pin 460 may be provided being arrangeable such that retraction of the pin 460 through the hole 514 is prevented. The interaction between the latch 461 and the surface surrounding the hole 514 thus locks the tensioning device 400 in place. The pin 460 may thus secure the device 400 in position such that the displacement mechanism 413 can be manipulated without risking that the device 400 for some reason becomes detached from the cassette 200. Only one locking pin 460 is shown, but is to be realized that a plurality of pins 460 may be provided.

It should be mentioned that the improved concept is by no means limited to the embodiments described herein, and several modifications are feasible without departing from the scope of the appended claims.

1. A chain tensioning device (400), comprising a base member (410) being provided with a centering member (440) being configured to be received by a cassette (200), said cassette (200) supporting a first sprocket (122) of a chain drive (120),
and a tensioning pin (450) being configured to be received in a recess (512) concentric with a second sprocket (124) of the chain drive (120) in the cassette (200), the second sprocket (124) being moveable at least in a radial direction in relation to the cassette (200),
wherein the chain tensioning device (400) further comprises a displacement mechanism (413) being configured to selectively manipulate the position of the tensioning pin (450) in relation to the centering member (440) between an idle state and a pre-loading state of a chain (126) of the chain drive (120).

2. The chain tensioning device (400) according to claim 1, wherein the centering member (440) comprises a plurality of centering pins (440).

3. The chain tensioning device (400) according to claim 2, wherein four centering pins (440) are distributed in a cross-shape.

4. The chain tensioning device (400) according to claim 1, wherein the displacement mechanism (413) comprises a screw acting on the tensioning pin (450).

5. The chain tensioning device (400) according to claim 1, further comprising at least one locking pin (460) receivable in a hole (514) in the cassette (200), wherein the locking pin (460) upon manipulation is configured to lock the chain tensioning device (400) in place against the cassette (200) to facilitate tensioning of the chain.

6. The chain tensioning device (400) according to claim 1, wherein the tensioning pin (450) is slidably supported by the base member (410) such that the tensioning pin (450) may move relative the base member (410) in a direction towards or away from the first sprocket (122).

7. A hybrid drive module, comprising a cassette (200) supporting a first sprocket (122) of a chain drive (120) and a second sprocket (124) of said chain drive (120), and a chain tensioning device (400) attached to said second sprocket (124) by inserting the tensioning pin (450) into a recess (512) concentric with said second sprocket (124) and to the cassette (200) by inserting the centering member (440) into at least one hole (510, 514) in the cassette (200), wherein the chain tensioning device (400) comprising a base member (410) being provided with a centering member (440) being configured to be received by the cassette (200), said cassette (200) supporting the first sprocket (122) of the chain drive (120),
and the tensioning pin (450) being configured to be received in a recess (512) concentric with the second sprocket (124) of the chain drive (120) in the cassette (200), the second sprocket (124) being moveable at least in a radial direction in relation to the cassette (200),
wherein the chain tensioning device (400) further comprises a displacement mechanism (413) being configured to selectively manipulate the position of the tensioning pin (450) in relation to the centering member (440) between an idle state and a pre-loading state of a chain (126) of the chain drive (120).

8. The hybrid drive module (100) according to claim 7, wherein the holes (510) into which the centering member (440) of the chain tensioning device (400) is insertable are crankshaft access holes (510).

9. The hybrid drive module (100) according to claim 7, wherein the holes (514) into which the centering member (440) of the chain tensioning device (400) is insertable are separate from crankshaft access holes (510).

10. An engine assembly (10) comprising an internal combustion engine (20) and a thereto mounted hybrid drive module (100) according to claim 7.

11. A method for tensioning a chain (126) of a chain drive (120) using the chain tensioning device (400) according to claim 1, said chain (126) connecting a first sprocket (122) supported by a cassette (200) and a second sprocket (124) in the cassette (200), the method comprising arranging (1001) the centering member (440) of the chain tensioning device (400) in at least one hole (510, 514) of the cassette (200), arranging (1002) the displaceable tensioning pin (450) of the chain tensioning device (400) in the recess (512) concentric with the second sprocket (124), and manipulating (1003) a distance between the centering member (440) and the tensioning pin (450) such that the chain (126) is pre-loaded to a predetermined level.

12. Method for tensioning a chain (126) according to claim 11, wherein said method further comprises mounting (1004) the cassette (200) with the chain tensioning device (400) to an engine (20), removing the chain tensioning device (400) after at least one screw (414, 511) attaching the cassette (200) to the engine (20) is tightened, and tightening the screws (414) which previously were non-accessible because of the presence of the chain tensioning device (400).
